(19) United States
(12) Patent Application Publication
(10) Pub. No.: US 2012/0303441 A1
(43) Pub. Date: Nov. 29, 2012

(54) COMPUTER-READABLE MEDIUM STORING INFORMATION PROCESSING PROGRAM, AND INFORMATION PROCESSING APPARATUS, SYSTEM, AND METHOD

(75) Inventor: Yasuhiko ISOBE, Inagi (JP)

(73) Assignee: FUJITSU LIMITED, Kawasaki-shi (JP)

(21) Appl. No.: 13/450,655

(22) Filed: Apr. 19, 2012

(30) Foreign Application Priority Data
May 26, 2011 (JP) 2011-117576

(51) Int. Cl. G06Q 30/02

(52) U.S. Cl. 705/14.39

(57) ABSTRACT

In an information processing apparatus, when registering the identifier of information acquired via a connection system, a registration unit registers the identifier with discount information attached thereto in the case where a discount applies to a communication charge for the information. The identifier and discount information are transferred to another information processing apparatus and registered in a storage unit. An information acquisition unit of the other information processing apparatus acquires the information identified by an identifier selected from the storage unit, via another connection system, and in the case where discount information has been attached to the selected identifier, receives a discount on a communication charge for acquiring the information.

### CROSS-REFERENCE TO RELATED APPLICATION

This application is based upon and claims the benefit of priority of the prior Japanese Patent Application No. 2011-117576, filed on May 26, 2011, the entire contents of which are incorporated herein by reference.

### FIELD

The embodiments discussed herein relate to a computer-readable medium storing an information processing program, and an information processing apparatus, system, and method.

### BACKGROUND

These days more and more users are viewing webpages with their mobile telephones, as well as Personal Computers (PCs). Such users have a demand to view webpages with their mobile telephones, which they usually view with their PCs. To meet this demand, there has been provided a system which enables a PC to register the Uniform Resource Locator (URL) of a webpage in a server when bookmarking the webpage as bookmark information on the PC so that the URL registered in the server is accessible from a mobile telephone. This system enables the PC and the mobile telephone to share the bookmark information.

In general, a communication charge incurred when a mobile telephone accesses the Internet via a mobile communication network is higher than that incurred when a PC accesses the Internet via an Internet provider. Therefore, many measures have been considered for reducing communication charges for communications using mobile devices such as mobile telephones. For example, there is a system that applies a discount rate to a communication charge for downloading a file from the server of a website to a mobile telephone, depending on whether the website is operated by a tie-up company of a mobile telephone company. Another system is that, when a mobile device accesses a server device via a relay apparatus, the relay apparatus performs a charging process depending on whether an information providing organization has set a charge for accessing the server device. Please refer to Japanese Laid-open Patent Publications Nos. 2008-97201, 2004-173192, and 2000-78129.

When a webpage that is usually viewed with a PC is viewed with a mobile telephone, a high communication charge may be incurred. Especially, mobile telephone users may be charged more for viewing PC-based websites than for viewing mobile version websites. Therefore, communication charges further increase when the users view webpages with their mobile telephones, which they usually view with their PCs.

As described above, there is a problem that a higher communication charge is incurred when information that was acquired via the system of a connection service is acquired with another information processing apparatus via the system of another connection service that has a different communication fee schedule.

### SUMMARY

According to an aspect, there is provided a computer-readable, non-transitory medium encoded with an information processing program executed by a computer connected to a network via a first connection system and having a function of registering an identifier of information acquired via the network and the first connection system in a memory provided in the computer. The information processing program causing the computer to perform a procedure includes: in registering the identifier in the memory, determining whether or not a discount applies to a communication charge for acquiring the information identified by the identifier via a second connection system, and upon determining that the discount applies, registering the identifier with discount information attached thereto in the memory; and transmitting the identifier and the discount information registered in the memory to another information processing apparatus connected to the network via the second connection system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example configuration of an information processing system according to a first embodiment;

FIG. 2 illustrates an example system configuration of an information processing system according to a second embodiment;

FIG. 3 illustrates an example hardware configuration of a PC;

FIG. 4 illustrates an example hardware configuration of a mobile telephone;

FIG. 5 illustrates an outline of how the information processing system operates;

FIG. 6 illustrates example information registered in a tie-up provider database;

FIG. 7 illustrates example information registered in a website database;

FIG. 8 is a block diagram illustrating an example configuration of processing functions of the PC;

FIG. 9 illustrates a first configuration example of connecting PCs to a provider system;

FIG. 10 illustrates a second configuration example of connecting PCs to a provider system;

FIG. 11 illustrates an example structure of a packet to be communicated with an IP address search server;

FIG. 12 is a flowchart illustrating a procedure performed by a provider search unit;

FIG. 13 is a flowchart illustrating an example of a procedure of a bookmark process;

FIG. 14 illustrates an example data structure of bookmark information stored in a PC;

FIG. 15 illustrates an example display of bookmark information on a PC;

FIG. 16 is a block diagram illustrating an example configuration of processing functions of a mobile telephone;

FIG. 17 is a sequence diagram illustrating how to transfer bookmark information;

FIG. 18 illustrates an example display of bookmark information on a mobile telephone;

FIG. 19 illustrates an example of internal configuration of a carrier system;

FIG. 20 is a flowchart illustrating an example of a procedure for displaying a webpage using bookmark information; and

FIG. 21 illustrates a process for encrypting bookmark information using the identification information of a mobile telephone.

### DESCRIPTION OF EMBODIMENTS

Several embodiments will be described below with reference to the accompanying drawings, wherein like reference numerals refer to like elements throughout.

### First Embodiment

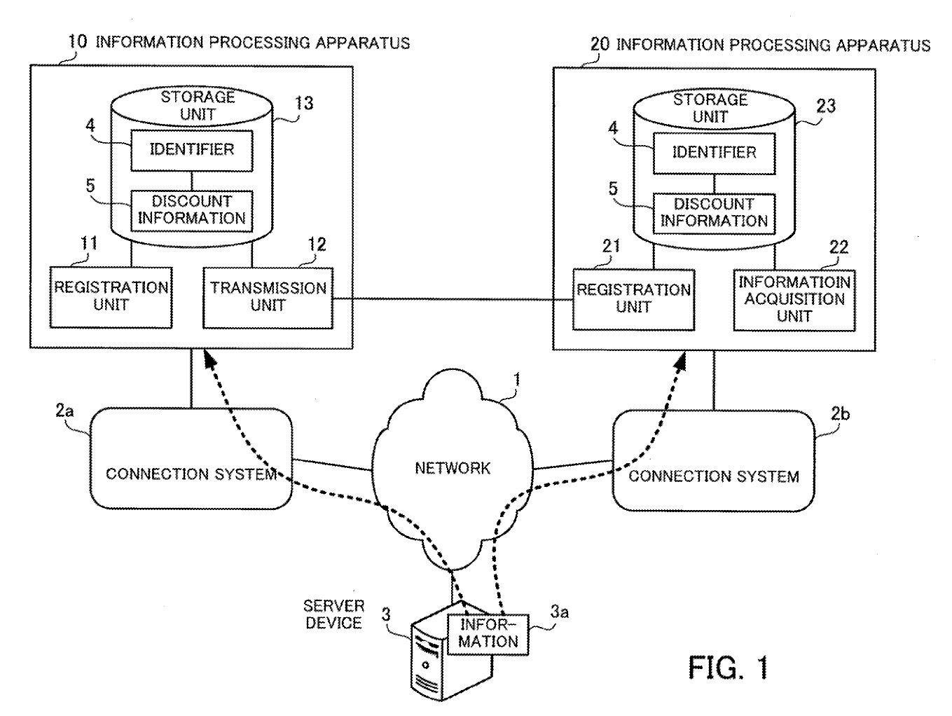

FIG. 1 illustrates an example configuration of an information processing system according to a first embodiment.

The illustrated information processing system includes two information processing apparatuses 10 and 20 that are connectable to a network 1. The information processing apparatus 10 is connected to the network 1 via a connection system 2a while the information processing apparatus 20 is connected to the network 1 via a connection system 2b.

The connection systems 2a and 2b are systems that are operated by different service providers that provide services for connecting to the network 1. For example, each connection system 2a and 2b includes a device for performing a process of connecting to the network 1, a device for managing communication charges, and other devices.

In this embodiment, assume that a communication charge for connecting to the network 1 via the connection system 2b is higher than that for connecting to the network 1 via the connection system 2a. For example, the connection system 2a is a system operated by an Internet provider while the connection system 2b is a system operated by a mobile communication company such as a mobile phone carrier.

As indicated by dotted arrows in FIG. 1, the information processing apparatus 10 is capable of acquiring information 3a via the network 1 and the connection system 2a while the information processing apparatus 20 is capable of acquiring the same information 3a via the network 1 and the connection system 2b. In the following description, assume that the information 3a is provided by a server device 3 connected to the network 1. The information 3a is data or a data set identified by an identifier such as a URL. The information 3a may be information for displaying the data of a webpage, or a data file for images, moving picture, or others. The information processing apparatuses 10 and 20 specify an identifier and access the network 1, thereby receiving the information 3a identified by the identifier from the server device 3.

The information processing apparatus 10 includes a registration unit 11, a transmission unit 12, and a storage unit 13. The operations of the registration unit 11 and transmission unit 12 are realized, for example, by a Central Processing Unit (CPU) of the information processing apparatus 10 executing predetermined programs. The storage unit 13 is realized by a non-volatile storage device such as a Hard Disk Drive (HDD), for example.

The registration unit 11 registers the identifier 4 of the information 3a, which the information processing apparatus 10 has acquired via the network 1 and connection system 2a, in the storage unit 13, for example, in accordance with user's input operation. When registering the identifier 4 in the storage unit 13, the registration unit 11 determines whether or not a discount applies to a communication charge for acquiring the information 3a identified by this identifier 4 via the other communication system 2b. In the case where the registration unit 11 determines that the discount applies to the communication charge, the registration unit 11 registers the identifier 4 with discount information 5 attached thereto in the storage unit 13. In the case where the discount does not apply, the registration unit 11 registers only the identifier 4 in the storage unit 13.

To determine whether a discount applies to a communication charge or not, the registration unit 11 makes an inquiry to a predetermined server device (not illustrated) connected to the network 1, for example. In this case, the registration unit 11 notifies the server device of the identifier 4 to be registered in the storage unit 13, for example. The server device sends the information processing apparatus 10 a response to the inquiry as to whether a discount applies to a communication charge for the information 3a identified by the received identifier 4.

The transmission unit 12 transmits the identifier 4 registered in the storage unit 13 to the information processing apparatus 20. In the case where the discount information 5 has been attached to the identifier to be transmitted, the transmission unit 12 transmits, to the information processing apparatus 20, the identifier 4 with the discount information 5 attached thereto. The identifier 4 and discount information 5 are preferably communicated between the information processing apparatuses 10 and 20 directly, not via a network, for example, using a Universal Serial Bus (USB) cable, Bluetooth (Registered Trademark), or another communication method.

The information processing apparatus 20 includes a registration unit 21, an information acquisition unit 22, and a storage unit 23. The operations of the registration unit 21 and information acquisition unit 22 are realized by a CPU of the information processing apparatus 20 executing predetermined programs, for example. The storage unit 23 is realized by a non-volatile storage device such as an HDD, for example.

The registration unit 21 registers the identifier 4 received from the transmission unit 12 of the information processing apparatus 10 in the storage unit 23. In the case where the discount information 5 has been attached to the identifier 4 received from the transmission unit 12, the registration unit 21 registers the identifier 4 with the discount information 5 attached thereto in the storage unit 23.

The identifier 4 is preferably registered in such a manner that the identifier 4 can easily be called up and selected by the user of the information processing apparatus 20. For example, in the case where the information 3a is a webpage and the identifier 4 is a URL, the identifier 4 is registered as bookmark information that is used by a web browser function of the information processing apparatus 20.

The information acquisition unit 22 acquires the information 3a identified by the identifier 4 selected from the storage unit 23 in accordance with user's input operation, via the network 1 and connection system 2b. The information acquisition unit 22 specifies the identifier 4 and accesses the network 1, thereby receiving the information 3a from the server device 3. In this acquisition process, the information acquisition unit 22 performs a discount process so as to receive a discount on a communication charge for the acquisition of the information 3a identified by the selected identifier 4 in the case where the discount information 5 has been attached to the selected identifier 4.

The discount process is performed as follows. The connection system 2b includes a plurality of connection units which each perform a process of connecting to the network 1. The information acquisition unit 22 accesses a different connection unit depending on whether the discount information 5 has been attached to the selected identifier 4 or not, and acquires the information 3a via the accessed connection unit. By setting different communication charges according to the connection units, a communication charge is reduced for acquiring the information 3a identified by the identifier 4 having the discount 5 attached thereto.

Another discount process may be performed, in which, in the case where the discount information 5 has been attached to the selected identifier 4, the information acquisition unit 22 includes discount request information requesting a discount in a packet and sends the packet when accessing the connection system 2b to acquire the information 3a. Then, a connection unit of the connection system 2b applies a discount to communications charge for transmitting the packet including the discount request information to the network 1 and for forwarding a response packet, as a response to the transmitted packet, from the network 1 to the information processing apparatus 20.

In the above-described first information processing system, a communication charge is reduced in the case where the other information processing apparatus 20 acquires the information 3 which the information processing apparatus 10 acquired via the connection system 2a, via the other connection system 2b. This allows the user to acquire the information 3a at lower cost even when the user uses the other information processing apparatus to acquire the information 3a which the user usually acquires with the information processing apparatus 10.

### Second Embodiment

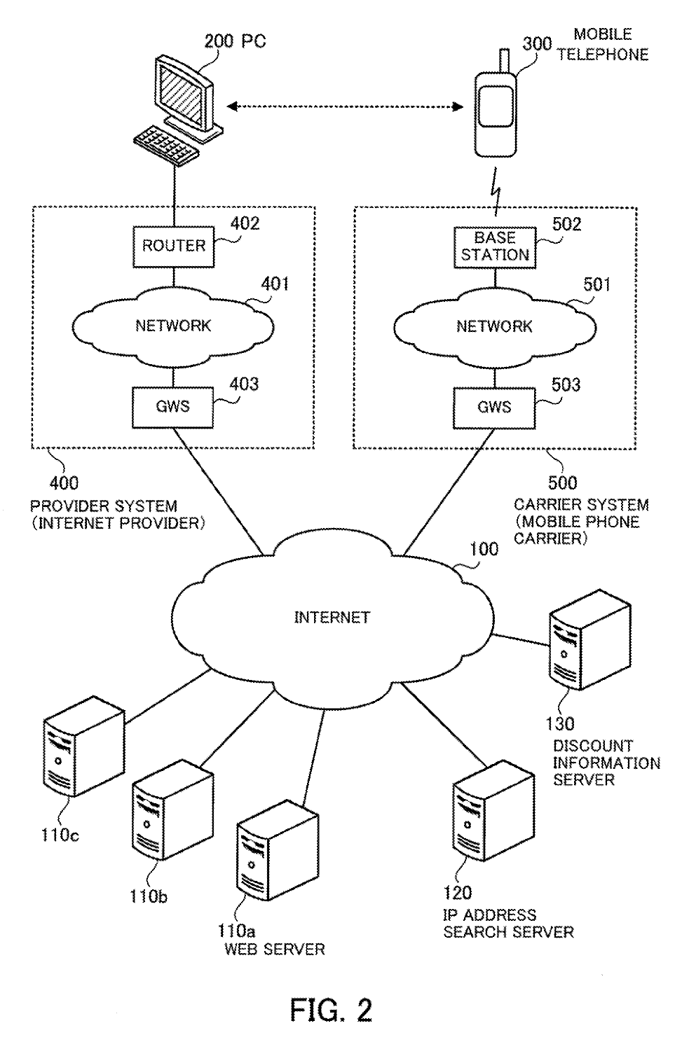

The following describes an information processing system which enables acquisition of webpage information, as an example of the information 3a of FIG. 1, from Web servers on the Internet. FIG. 2 illustrates an example system configuration of an information processing system according to a second embodiment.

The illustrated information processing system is designed so that user's terminal devices are connectable to the Internet 100. In this embodiment, a user uses two terminal devices, PC 200 and mobile telephone 300.

Referring to FIG. 2, the PC 200 is one of user's terminal devices. A provider system 400 is operated by an Internet provider that provides a service for connecting to the Internet 100. The PC 200 connects to the Internet 100 via the provider system 400.

The provider system 400 includes, for example, a network 401, a router 402, a gateway server (GWS) 403, and others. The network 401 is an Internet protocol (IP) network, for example. The router 402 relays data between the local network 401 of the provider system 400 and each terminal device (PC 200 in FIG. 2) of users who have signed up with the Internet provider. The gateway server 403 relays data between the network 401 and the Internet 100. In addition, the gateway server 403 may be designed to perform an authentication process and charging process for data communications by interacting with, for example, a subscriber database server (not illustrated) connected to the network 401.

On the other hand, the mobile telephone 300 in FIG. 2 is an example of user's another terminal device. The mobile telephone 300 connects to the Internet 100 via a carrier system 500 operated by a mobile phone carrier. Terminal devices that connect to the carrier system 500 include various information processing apparatuses such as laptop computers, as well as mobile telephones.

The carrier system 500 includes a network 501, a base station 502, a gateway server (GWS) 503, and others, for example. The network 501 is a network where communications are performed under a protocol unique to the mobile phone carrier. The base station 502 wirelessly communicates with the terminal devices of users that have signed up with the mobile phone carrier, and relays data between the terminal devices and the network 501. In actual, there is a plurality of base stations 502. The gateway server 503 relays data between the network 501 and the Internet 100. At the time of data relay, the gateway server 503 converts the protocol used by the network 501 into the protocol used by the Internet 100, and vice versa.

In addition, a plurality of Web servers 110a to 110c that provide websites is connected to the Internet 100. The PC 200 accesses a Web server 110a to 110c via the provider system 400, so as to display a page of a website provided by the Web server on a monitor connected to the PC 200. In addition, the mobile telephone 300 accesses a Web server 110a to 110c via the carrier system 500, so as to display a page of a website provided by the Web server on the monitor of the mobile telephone 300.

Furthermore, an IP address search server 120 and discount information server 130 are connected to the Internet 100. When receiving a search request via the Internet 100, the IP address search server 120 includes the source IP address included in a received packet, in the data region of a transmit packet, and sends back the transmit packet as a response. The discount information server 130 is a server device that is operated by the mobile phone carrier. The discount information server 130 provides discount information on communication charges of the mobile phone carrier over the Internet 100.

The PC 200 and mobile telephone 300 are capable of connecting with each other via, for example, a USB cable.

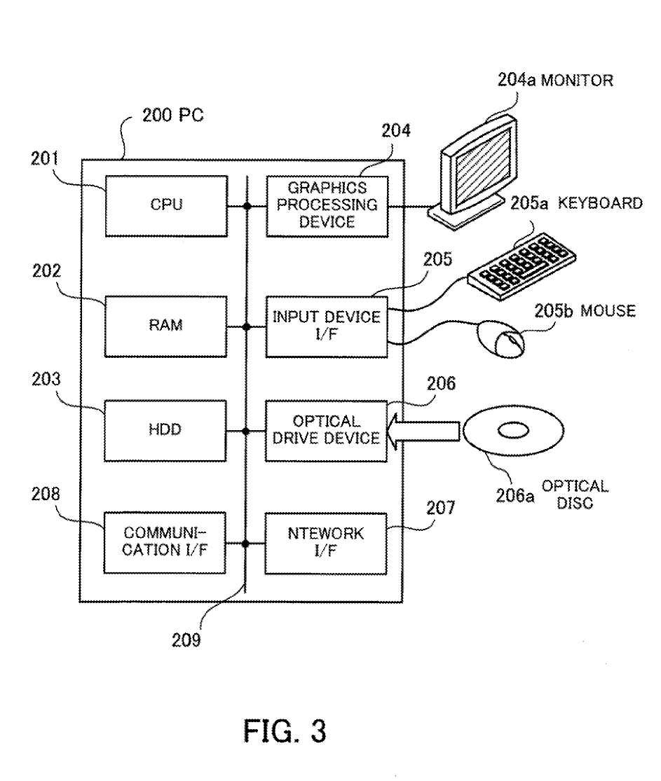

FIG. 3 illustrates an example hardware configuration of a PC.

The PC 200 is entirely controlled by the CPU 201. To the CPU 201, a Random Access memory (RAM) 202 and a plurality of peripheral devices are connected via a bus 209.

The RAM 202 is used as a main memory of the PC 200. The RAM 202 temporarily stores part of Operating System (OS) programs and application programs to be executed by the CPU 201. The RAM 202 also stores various data to be used while the CPU 201 runs.

The peripheral devices connected to the bus 209 include an HDD 203, a graphics processing device 204, an input device interface (I/F) 205, an optical drive device 206, a network interface 207, and a communication interface 208.

The HDD 203 magnetically reads and writes data on a built-in magnetic disk. The HDD 203 is used as a secondary memory of the PC 200. The HDD 203 stores the OS programs, application programs, and various data. In this connection, a semiconductor memory device such as a flash memory may be used as a secondary memory.

To the graphics processing device 204, a monitor 204a is connected. The graphics processing device 204 displays an image on the monitor 204a under the control of the CPU 201. In this connection, the monitor 204a is a liquid crystal display, for example.

To the input device interface 205, a keyboard 205a and a mouse 205b are connected, for example. The input device interface 205 transfers output signals of the keyboard 205a and mouse 205b to the CPU 201. The mouse 205b is an example of pointing devices. A pointing device of another kind, for example, a touch panel, tablet, touch pad, or trackball may be used.

The optical drive device 206 reads data recorded on an optical disc 206a with a laser beam or the like. The optical disc 206a is a portable recording medium on which data is recorded so as to be read through light reflection. Optical discs 206a include Digital Versatile Disc (DVD), DVD-RAM, Compact Disc Read Only Memory (CD-ROM), and CD-R (Readable)/RW (Rewritable).

The network interface 207 is connected to a network in a building where the PC 200 is installed. The network interface 207 connects to the router 402 of the provider system 400 via a broadband router or the like installed in the building.

The communication interface 208 communicates with another device by wire or wirelessly. In this embodiment, the PC 200 is designed to communicate with the mobile telephone 300 via the communication interface 208. For example, a USB cable may be used for wired communications, and Bluetooth may be used for wireless communications.

In this connection, the Web servers 110a to 110c, IP address search server 120, and discount information server 130 may have the same hardware configuration as illustrated in FIG. 3.

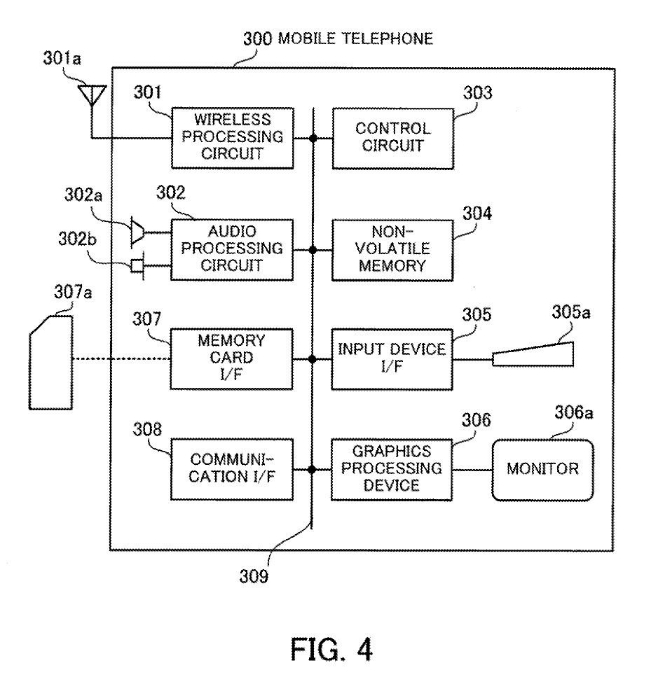

FIG. 4 illustrates an example hardware configuration of a mobile telephone.

The mobile telephone 300 includes a wireless processing circuit 301, an audio processing circuit 302, a control circuit 303, a non-volatile memory 304, an input device interface 305, a graphics processing device 306, a memory card interface 307, and a communication interface 308. These devices are connected to each other via a bus 309.

To the wireless processing circuit 301, an antenna 301a for wirelessly communicating with the base station 502 of the carrier system 500 is connected. The wireless processing circuit 301 demodulates signals received via the antenna 301a to extract data, and also generates and modulates data to be transmitted.

To the audio processing circuit 302, a speaker 302a and a microphone 302b are connected. During a call, the audio processing circuit 302 encodes and supplies audio signals collected by the microphone 302b to the wireless processing circuit 301. At the same time, the audio processing circuit 302 amplifies the audio signals obtained by demodulating received radio waves by the wireless processing circuit 301, and outputs the communication sounds from the speaker 302a.

The control circuit 303 includes a CPU, a RAM, and others in order to entirely control the mobile telephone 300. For example, the control circuit 303 controls a call process and data communication process that are performed via the wireless processing circuit 301, and executes application programs stored in the non-volatile memory 304.

The non-volatile memory 304 stores various programs to be executed by the control circuit 303, and various data to be used while programs run. The non-volatile memory 304 is realized as a semiconductor memory such as a flash memory. Instead of the non-volatile memory 304, a non-volatile storage medium of another kind, such as an HDD, may be used.

To the input device interface 305, input keys 305a are connected. The input device interface 305 transfers output signals of the input keys 305a to the control circuit 303. The input keys 305a are one example of input devices, and an input device of another kind such as a touch panel that is provided in the monitor 306a may be used.

To the graphics processing device 306, a monitor 306a is connected. The monitor 306a may be a liquid crystal display or organic Electroluminescent (EL) display. The graphics processing device 306 displays an image on the monitor 306a under the control of the control circuit 303.

To the memory card interface 307, a memory card 307a that is a portable storage device using a flash memory as a storage device is connected. The memory card interface 307 outputs data read from the memory card 307a to the control circuit 303. In addition, the memory card interface 307 writes data to the memory card 307a in response to a write request from the control circuit 303.

The communication interface 308 communicates with another device under the same communication standards as the communication interface 208 of the PC 200. In this embodiment, the mobile telephone 300 communicates with the PC 200 via the communication interface 308.

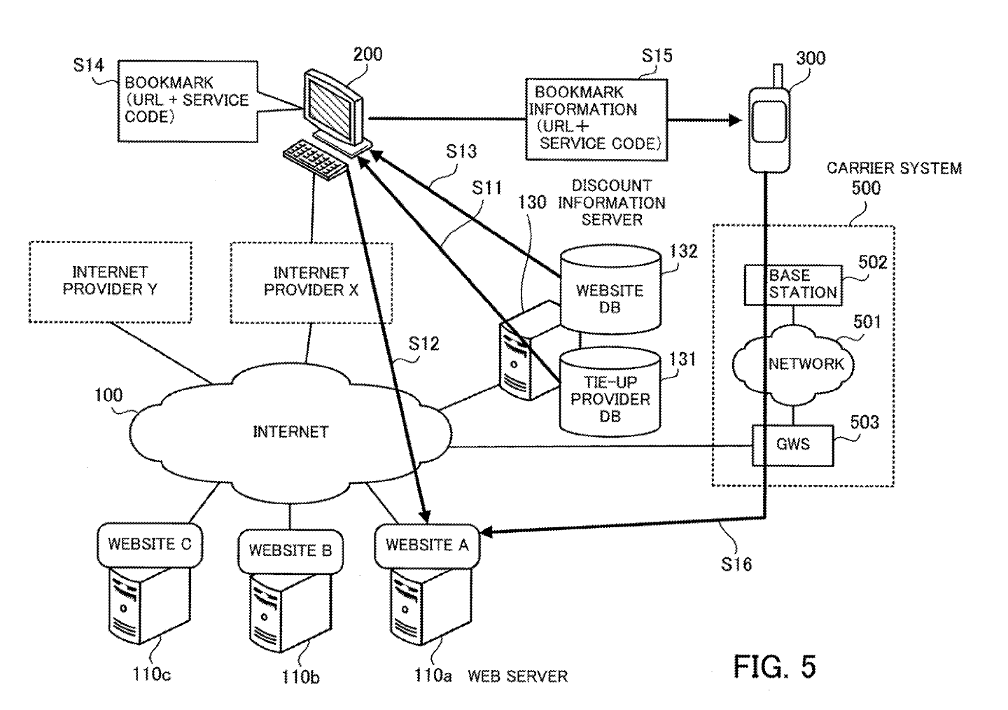

FIG. 5 illustrates an outline of how an information processing system operates.

A mobile phone carrier which operates the carrier system 500 provides the following discount service for communication charges for connecting to the Internet 100 via the carrier system 500. Under the condition that the PC 200 accessed a specified website via a specified Internet provider, the mobile phone carrier applies a discount to a communication charge when the mobile telephone 300 accesses the website via the carrier system 500.

The mobile phone carrier previously registers Internet providers and websites available with a discount service in a storage device of the discount information server 130. The storage device of the discount information server 130 stores a tie-up provider database (DB) 131 and a website database 132.

The tie-up provider database 131 contains information identifying Internet providers available with the discount service. For example, as illustrated in FIG. 5, assume that there are two Internet providers X and Y that provide a service of connecting to the Internet 100. In addition, assume that the mobile phone carrier has set the Internet provider X out of these to be available with the discount service. In this case, the tie-up provider database 131 contains the provider name of the Internet provider X, a range of global IP addresses used by the Internet provider X, or the like.

The website database 132 contains information identifying websites available with the discount service. For example, as illustrated in FIG. 5, assume that Web servers 110a, 110b, 110c that provide websites A, B, and C, respectively, are connected to the Internet 100. In addition, assume that the mobile phone carrier has set the website A out of these to be available with the discount service. In this case, the website database 132 contains information identifying webpages included in the website A (for example, the domain name in the URL of the website A).

In the case where the tie-up provider database 131 and website database 132 contain information as described above, the following discount service is carried out. Under the condition that the user viewed the website A with the PC 200 connected to the Internet 100 via the connection system of the Internet provider X, the user can receive a discount for viewing the same website A with the mobile telephone 300. However, in the case where the PC 200 was connected to the Internet 100 via the connection system of the Internet provider Y or the user viewed the website B or C with the PC 200, the user is not able to receive a discount for viewing the website B or C with the mobile telephone 300.

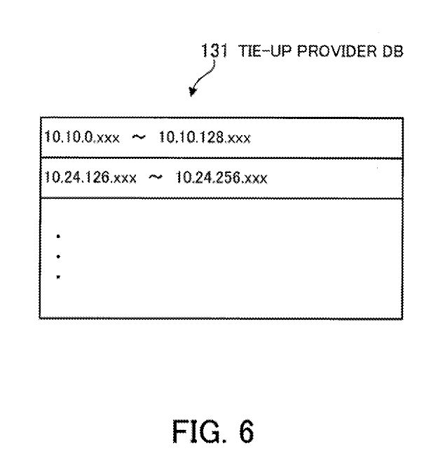

FIG. 6 illustrates example information registered in a tie-up provider database.

The tie-up provider database 131 contains a range of global IP addresses used by an Internet provider available with a discount service, for example. The global IP addresses here are addresses that are written as a source IP address in a packet to be transmitted to the Internet 100 when a terminal device accesses the Internet 100 via a provider system. In the case where there is a plurality of Internet providers available with the discount service, a plurality of ranges of IP addresses is registered in the tie-up provider database 131.

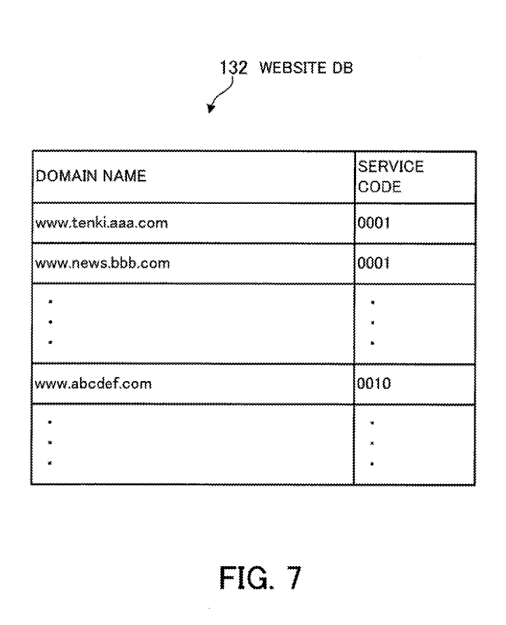

FIG. 7 illustrates example information registered in a website database.

The website database 132 contains the domain names of websites available with a discount service. In association with a domain name, a service code may be registered in the website database 132. The service code is information indicating a discount service type, and for example, is a unique value indicating a discount rate for a communication charge. For example, “0001” indicates a discount rate of 10%, and “0010” indicates a discount rate of 20%. Setting such service information for each domain name allows different discount rates to be offered for respective websites. In the case where a fixed discount rate is set for websites, such service codes may not be registered.

In the above examples of FIGS. 6 and 7, different discount rates are set for respective websites. In addition to this, different discount rates may be set for respective Internet providers that are accessed for viewing of websites. In this case, a service code is registered in association with the range of IP addresses of each Internet provider in the tie-up provider database 131, for example.

Referring back to FIG. 5, the PC 200 notifies the mobile telephone 300 of an access of the PC 200 to a specified website via a specified Internet provider by using bookmark information. The bookmark information is URL information of a webpage that was registered in the PC in accordance with user's operation when the webpage was displayed in a Web browser. The user is allowed to call up bookmark information on the screen of the web browser to thereby display the webpage corresponding to the URL indicated in the called-up bookmark information on the screen of the Web browser.

The following describe how a user can receive a discount service for a communication charge of the mobile telephone 300, step by step.

First, the PC 200 determines, for example, at predetermined intervals, whether a provider system connecting with the PC 200 is the system of an Internet provider available with a discount service. To this end, the PC 200 accesses the IP address search server 120 to recognize a global IP address used for connecting to the Internet 100. The PC 200 then notifies the discount information server 130 of the recognized global IP address to make an inquiry as to whether the recognized IP address has been registered in the tie-up provider database 131. In the case where the IP address exists in the tie-up provider database 131, the discount information server 130 notifies the PC 200 of this result (step S11).

Then, the Web browser of the PC 200 starts up according to user's operation, and the PC 200 accesses a Web server to display a webpage on the screen of the Web browser (step S12). When the user bookmarks the URL of the webpage currently displayed, the PC 200 determines whether both the Internet provider operating the currently connected provider system and the bookmarked webpage are available with a discount service.

In the case where a result of the above-described process indicates that the currently connected provider system is the system of an Internet provider available with the discount service, the PC 200 further notifies the discount information server 130 of the bookmarked URL to make an inquiry as to whether the URL has been registered in the website database 132. In the case where the URL exists in the website database 132, the discount information server 130 notifies the PC 200 of the service code corresponding to the URL (step S13).

In the case where both of the Internet provider that operates the currently connected provider system and the bookmarked webpage are available with the discount service, the PC 200 attaches the service code received from the discount information server 130 to the URL, and registers the URL with the service code attached thereto in the bookmark information (step S14). In the case where the currently connected provider system is not the system of an Internet provider available with a discount service or the bookmarked webpage is not available with a discount service, the PC 200 registers only the URL in the bookmark information.

Then, the user connects the mobile telephone 300 to the PC 200. When detecting the connection to the mobile telephone 300, the PC 200 gives the registered bookmark information to the mobile telephone 300, for example, automatically (step S15). In the case where a service code has been attached to the URL, the PC 200 sends the service code together with the URL to the mobile telephone 300.

The mobile telephone 300 uses the received bookmark information as the bookmark information of a Web browser of the mobile telephone. The user calls up the bookmark information on the screen of the Web browser of the mobile telephone 300, and selects a URL registered in the bookmark information. The mobile telephone 300 accesses the selected URL, thereby displaying the webpage indicated by the URL on the monitor 306a of the mobile telephone 300 (step S16).

When accessing the URL selected from the bookmark information, the mobile telephone 300 determines whether a service code has been attached to the URL. In the case where the service code has been attached to the URL, the mobile telephone 300 is able to receive a discount on the communication charge according to the service code. To this end, the mobile telephone 300 accesses, for example, a proxy server corresponding to the service code, provided in the carrier system 500, and accesses the Web server via the proxy server.

According to the process of FIG. 5, the user is able to view a website with the mobile telephone 300 at a discounted communication charge, which the user usually views with the PC 200, for example. What the user needs to do to receive the discount service is only to connect the PC 200 with the mobile telephone 300. The other processes are automatically executed by the PC 200 and mobile telephone 300. This means that the user is able to receive the discount service through very simple operations.

In addition, the mobile phone carrier is able to increase chances to get their websites viewed by users by setting websites relevant to the mobile phone carrier to be available with a discount service. In this case, the mobile phone carrier offers a discount service for communication charges to users for viewing of the websites relevant to the mobile phone carrier.

Further, the mobile phone carrier may set websites of companies that have a business tie-up with the mobile phone carrier to be available with a discount service. In this case, the mobile phone carrier may establish such a business model that the mobile phone carrier receives some fees from the companies which provide the websites, in exchange for increasing chances to get the websites viewed, in compensation for reducing communication charges for the viewing of the websites via the carrier system 500.

Furthermore, the mobile phone carrier may set Internet providers which have a business tie-up with the mobile phone carrier to be available with a discount service. This produces a merit that both the mobile phone carrier and the Internet provider may have more subscribers.

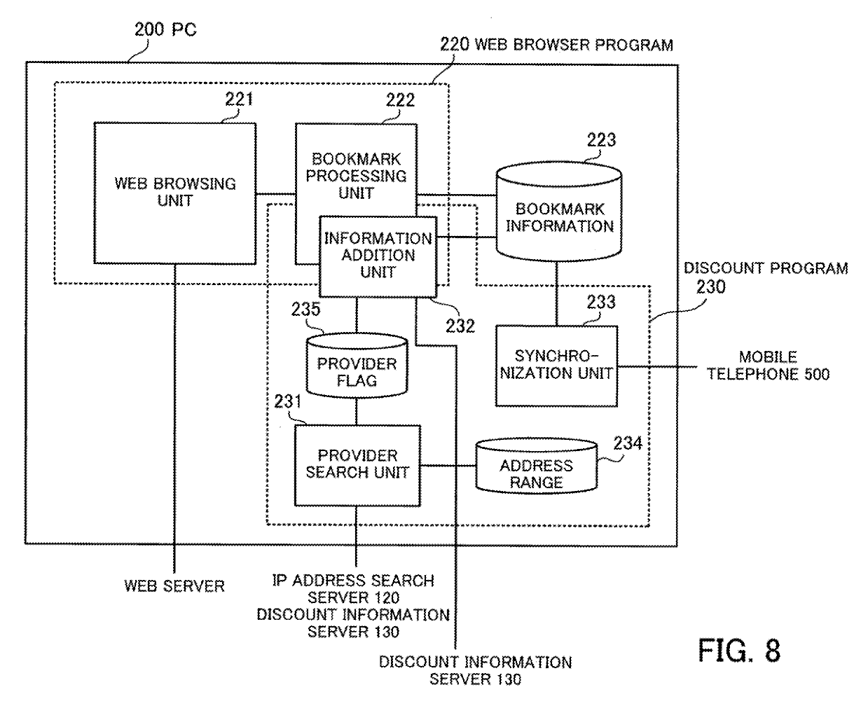

The following describes processes of the PC 200. FIG. 8 is a block diagram illustrating an example configuration of processing functions of a PC.

The PC 200 includes a Web browsing unit 221, a bookmark processing unit 222, a provider search unit 231, an information addition unit 232, and a synchronization unit 233. The processes of the Web browsing unit 221 and bookmark processing unit 222 are realized by the CPU 201 of the PC 200 executing a Web browser program 220, for example. On the other hand, the processes of the provider search unit 231, information addition unit 232, and synchronization unit 233 are realized by the CPU 201 of the PC 200 executing a discount program 230, for example. When the discount program 230 is installed in the PC 200, a program portion for executing the processes of the information addition unit 232 in the discount program 230 is installed as a plug-in for the Web browser program 220.

In addition, the PC 200 stores bookmark information 223, an address range 234, and a provider flag 235. The bookmark information 223 and address range 234 are stored, for example, on the HDD 203 of the PC 200, while the provider flag 235 is stored, for example, in the RAM 202 of the PC 200.

The Web browsing unit 221 communicates with a Web server to display a webpage provided by the Web server on the monitor 204a.

When receiving a bookmark request while the Web browsing unit 221 displays a webpage, the bookmark processing unit 222 acquires the name and URL of the webpage currently displayed from the Web browsing unit 221, and registers them in the bookmark information 223. In addition, when receiving selection of a webpage name registered in the bookmark information 223, the bookmark processing unit 222 notifies the Web browsing unit 221 of the URL corresponding to the selected webpage to make a request for displaying the webpage. The Web browsing unit 221, having received the request, accesses the Web server indicated by the URL received from the bookmark processing unit 222, and displays the webpage provided by the accessed Web server on the monitor 204a.

The provider search unit 231 determines whether a currently connected provider system is the system of an Internet provider available with a discount service. The provider search unit 231 checks the address range 234 indicating a range of private IP addresses. In the address range 234, ranges of IP addresses usable as private IP addresses (for example, 10.0.0.0 to 10.255.255.255, 172.16.0.0 to 172.31.255.255, 192.168.0.0 to 192.168.255.255, etc.) are registered.

The provider search unit 231 recognizes a global IP address to be used by the PC 200 to connect to the Internet 100, from the information registered in the address range 234 and a response received from the IP address search server 120. The provider search unit 231 notifies the discount information server 130 of the global IP address to make an inquiry as to whether the Internet provider having the recognized global IP address is available with a discount service.

The provider search unit 231 sets the provider flag 235 to “1” in the case where the result of the inquiry indicates that the currently connected provider system is the system of an Internet provider available with the discount service. In the case where the currently connected provider system is not the system of an Internet provider available with the discount service, the provider search unit 231 sets the provider flag 235 to “0”.

In the case where the provider flag 235 is “1” when the bookmark processing unit 222 bookmarks a URL, the information addition unit 232 determines whether the webpage indicated by the URL registered in the bookmark information 223 is available with a discount service. To this end, the information addition unit 232 notifies the discount information server 130 of the bookmarked URL to make an inquiry as to whether the bookmarked URL is available with a discount service. In the case where the result of the inquiry to the discount information server 130 indicates that the bookmarked URL is available with the discount service, the information addition unit 232 receives a service code from the discount information server 130, and attaches the received service code to the URL registered in the bookmark information 223.

When detecting a connection of the PC 200 to the mobile telephone 300, the synchronization unit 233 automatically starts up. The synchronization unit 233 then sends the registered bookmark information 223 to the connected mobile telephone 300.

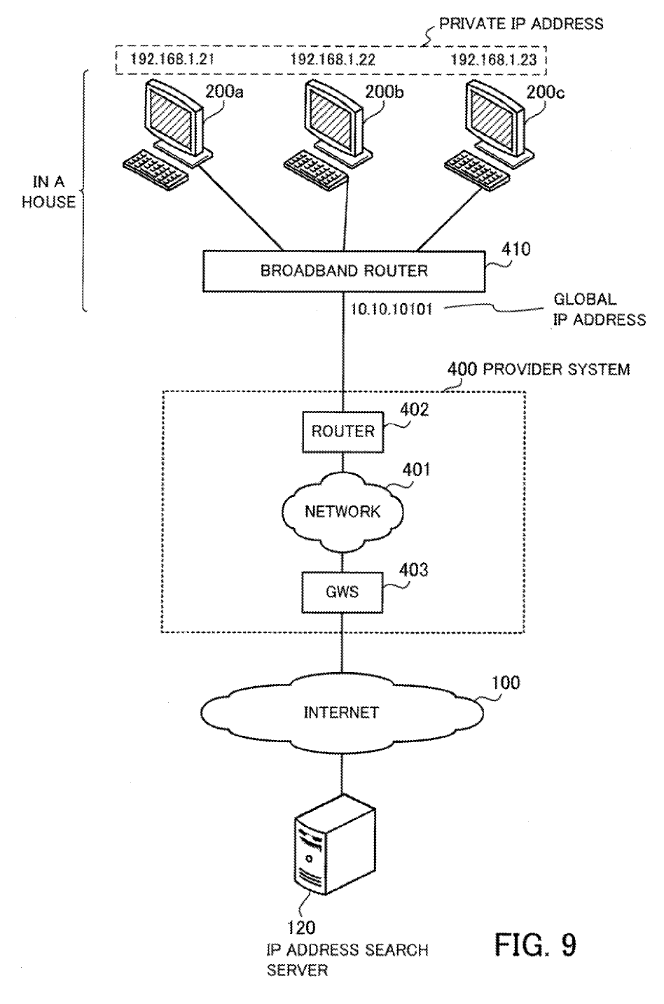

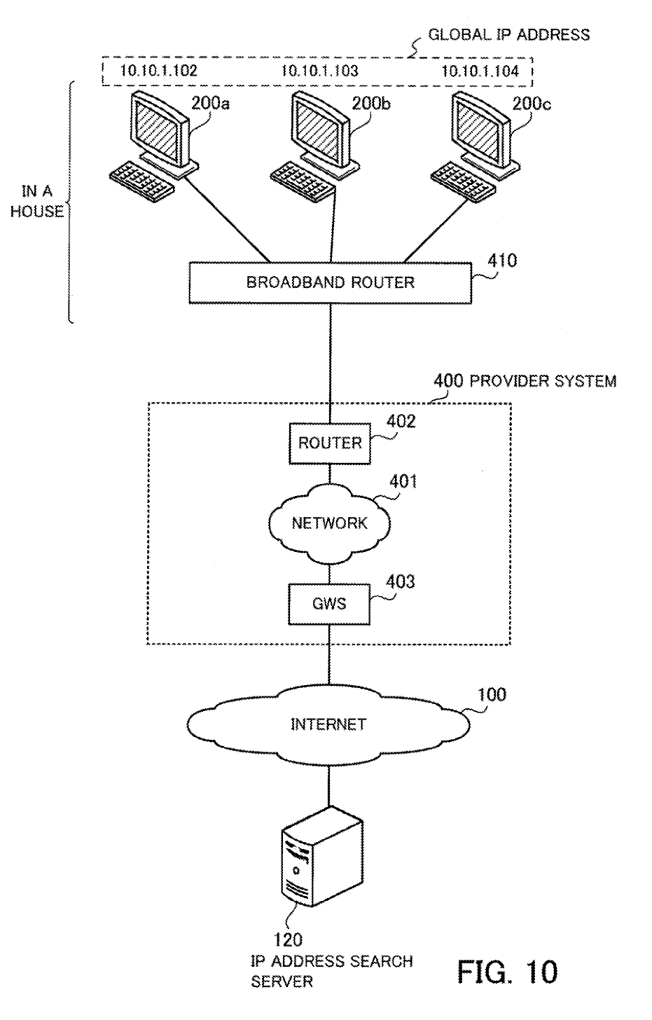

The following describes processes of the provider search unit 231. FIG. 9 illustrates a first configuration example of connecting PCs to a provider system. FIG. 10 illustrates a second configuration example of connecting PCs to a provider system.

In FIGS. 9 and 10, assume that there are three PCs 200a to 200c connected to each other in a house, and each PC 200a to 200c connects to a router 402 of a provider system 400 via a broadband router 410. In this configuration, there are two cases considered: one case is that a global IP address is assigned to a Wide Area Network (WAN) side of the broadband router 410, as illustrated in FIG. 9; and the other case is that global IP addresses are assigned to respective PCs 200a to 200c, as illustrated in FIG. 10.

In the case where the global IP addresses are assigned to the respective PCs 200a to 200c, as illustrated in FIG. 10, the provider search unit 231 of each PC 200a to 200c recognizes that the IP address of the own PC is usable as a global IP address for connecting to the Internet 100. In the case where the global IP address is assigned to the WAN side of the broadband router 410, as illustrated in FIG. 9, on the other hand, private IP addresses automatically set by the broadband router 410 (or manually set by a user) are assigned to the respective PCs 200a to 200c. In this case, the provider search unit 231 of each PC 200a to 200c makes an inquiry as to a global IP address usable for connecting to the Internet 100, to the IP address search server 120.

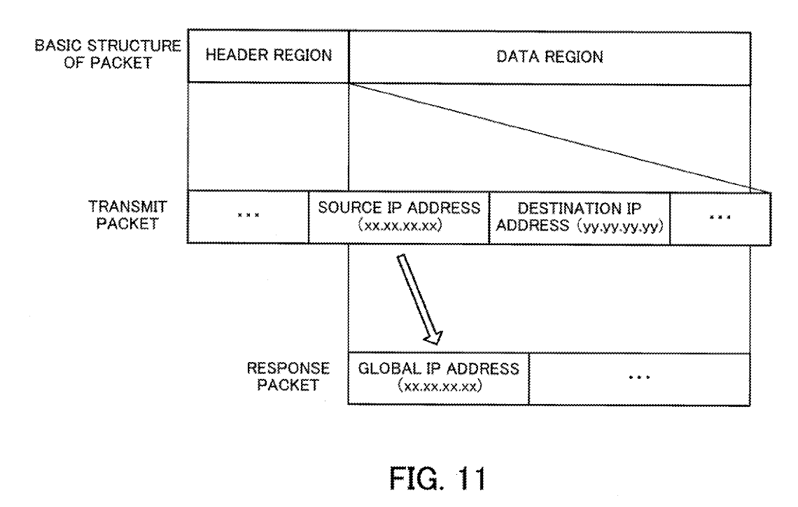

FIG. 11 illustrates an example structure of a packet to be communicated with an IP address search server.

A transmit packet from a PC to the IP address search server 120 and a response packet returned from the IP address search server 120 to the PC both have a basic structure in which a header region is provided in the beginning and a data region follows. In the header region, a source IP address and a destination IP address are set. In the case where a global IP address is assigned to the WAN side of the broadband router 410, as illustrated in FIG. 9, the source IP address set in the header region of a transmit packet transmitted from the PC 200a, for example, is rewritten from a private IP address to a global IP address by the broadband router 410.

When receiving a transmit packet from the broadband router 410 via the provider system 400 and the Internet 100, the IP address search server 120 extracts a source IP address from the header region thereof. The IP address search server 120 sets the extracted source IP address in the data region of a response packet to be returned to the PC 200a. The source IP address that is set at this time is a global IP address to be used by the PC 200a to connect to the Internet 100, and the PC 200a recognizes the global IP address from the data region of the response packet received from the IP address search server 120.

In this connection, the IP address search server 120 may trace a path which forwarded a packet received from a PC and notify the PC of a global IP address, instead of using the source IP address included in the received packet as described above.

In addition, the configuration example of FIG. 9 is that a global IP address is assigned to the WAN side of the broadband router 410. Alternatively, there is another case where a private IP address specified by an Internet provider may be assigned to the WAN side of the broadband router 410. In this case, for example, the source IP address of a packet transmitted from the PC 200a is converted by the broadband router 410, and then is converted again into a global IP address by the gateway server 403 of the provider system 400. In this configuration, the provider search unit 231 of the PC 200a is able to recognize the global IP address usable for connecting to the Internet 100 by making an inquiry to the IP address search server 120.

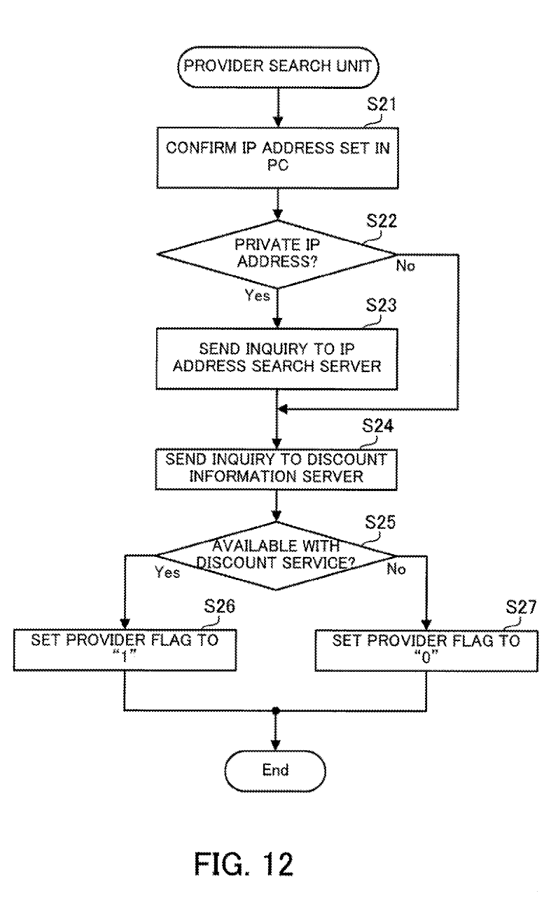

FIG. 12 is a flowchart illustrating a procedure performed by a provider search unit.

At step S21, the provider search unit 231 confirms an IP address set in the PC 200. To this end, the provider search unit 231 issues an “ipconfig.sys” command to, for example, an IP address notification function provided by an OS.

At step S22, the provider search unit 231 determines whether the IP address of the PC 200, confirmed at the step S21, is included in a range of private IP addresses registered in the address range 234. In the case where the provider search unit 231 determines that the IP address of the PC 200 has been registered in the address range 234 and this IP address is a private IP address, the provider search unit 231 executes step S23. In the case where the IP address of the PC 200 has not been registered in the address range 234 and this IP address is a global IP address, the provider search unit 231 executes step S24.

At step S23, the provider search unit 231 accesses the IP address search server 120 to make an inquiry as to a global IP address usable for connecting to the Internet 100. The provider search unit 231 recognizes the global IP address from a response packet received from the IP address search server 120.

At step S24, the provider search unit 231 sends the discount information server 130 the IP address of the PC 200 determined as a global IP address at step S22 or the global IP address received from the IP address search server 120 at step S23, in order to make an inquiry as to whether the global IP address has been assigned to an Internet provider available with a discount service.

At step S25, the provider search unit 231 determines based on a response to the inquiry of step S24 whether the global IP address sent to the discount information server 130 has been assigned to an Internet provider available with a discount service. In this connection, in the case where the sent global IP address has been assigned to an Internet provider available with a discount service, the provider search unit 231 receives a service code from the discount information server 130.

In the case where the global IP address has been assigned to an Internet provider available with a discount service, the provider search unit 231 executes step S26. Otherwise, the provider search unit 231 executes step S27.

At step S26, the provider search unit 231 sets the provider flag 235 to “1” as the determination of step S25 results in “yes”, meaning that the currently connected provider system is the system of an Internet provider available with a discount service.

At step S27, the provider search unit 231 sets the provider flag 235 to “0” as the determination of step S25 results in “no”, meaning that the currently connected provider system is not the system of an Internet provider available with a discount service.

The procedure of FIG. 12 is repeatedly performed at predetermined intervals. This allows the provider flag 235 to always indicate whether or not a currently connected provider system is the system of an Internet provider available with a discount service. Alternatively, the procedure of FIG. 12 may be performed when a Web browser is displayed by the Web browsing unit 221 on the monitor 204a of the PC 200, and after that, may be periodically performed until the Web browser is closed. Yet alternatively, the procedure of FIG. 12 may be performed when the user bookmarks a URL while displaying a Web browser.

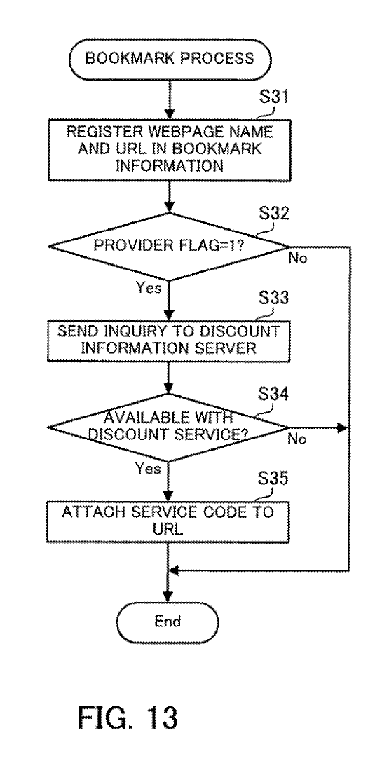

The following describes how to perform a bookmark process in the PC 200. FIG. 13 is a flowchart illustrating an example of a procedure of a bookmark process.

At step S31, when a user performs a bookmark operation while a webpage is displayed by the Web browsing unit 221 on the monitor 204a of the PC 200, the bookmark processing unit 222 acquires the name and URL of the currently displayed webpage from the Web browsing unit 221, and registers the acquired name and URL in the bookmark information 223. In this connection, when registering the name and URL of a webpage in the bookmark information 223, the bookmark processing unit 222 is able to specify a folder for displaying the name of the webpage on a bookmark screen in accordance with user's instruction operation.

At step S32, the information addition unit 232 checks the provider flag 235. In the case where the provider flag 235 is “1”, the information addition unit 232 executes step S33. In the case where the provider flag 235 is “0”, the information addition unit 232 completes this bookmark process.

At step S33, as the provider flag 235 is “1”, meaning that the currently connected provider system is the system of an Internet provider available with a discount service, the information addition unit 232 sends the URL registered in the bookmark information 223 at step S31 to the discount information server 130 in order to make an inquiry as to whether the webpage indicated by the URL is available with a discount service.

At step S34, in the case where a response from the discount information server 130 indicates that the URL sent at step S33 is available with a discount service, the information addition unit 232 executes step S35. At this time, in the case where the URL is available with a discount service, the information addition unit 232 receives a service code from the discount information server 130. In the case where the URL sent at step S33 is not available with a discount service, the information addition unit 232 completes this bookmark process.

At step S35, the information addition unit 232 attaches the service code received from the discount information server 130 to the URL registered in the bookmark information 223 at step S31.

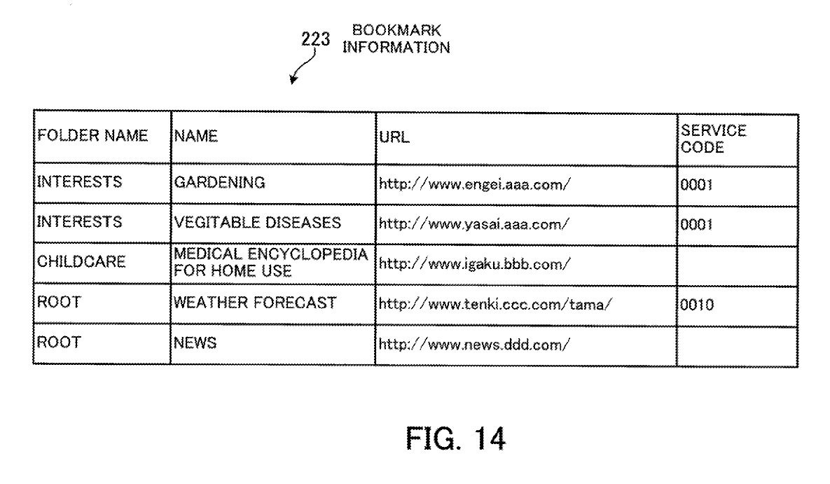

FIG. 14 illustrates an example data structure of bookmark information stored in a PC. As illustrated in FIG. 14, the bookmark information 223 stored in the PC 200 has fields for folder name, name, URL, and service code.

The name field contains the name of a bookmarked webpage. The URL field contains the URL of the bookmarked webpage. The service code field contains a service code indicating a discount rate for the case where a discount service is provided for a communication charge for viewing of the bookmarked webpage via a mobile phone carrier.

With respect to webpages which are not available with discount services, the service code field is blank. Alternatively, with respect to such webpages that are not available with discount services, a specified value (such as “0000”) may be registered in the service code field.

In addition, the bookmark processing unit 222 is capable of displaying the names of webpages registered in the bookmark information 223 in hierarchical manner. Referring to the example of FIG. 14, the names of webpages are displayed in two hierarchies: a root hierarchy and a lower hierarchy. In the folder name field, information on the hierarchy for displaying the name of a corresponding webpage is registered. In the case where “root” is set in the folder name field, the name of a corresponding webpage is displayed in the root hierarchy. In the case where a folder name, such as “interests”, is set in the folder name field, the name of a corresponding webpage is displayed under a folder with the folder name.

Information registered in the service code field, out of information registered in the bookmark information 223, is preferably made confidential against outside. This is because the service code is information that proves that the PC 200 accessed a specified website via a specified Internet provider, and needs to be prevented from being used fraudulently.

In addition, out of the information registered in the bookmark information 223, a combination of information in the service code field and information indicating a corresponding URL may be stored in a file separately from information contained in the other fields. In this case, for example, only a file that contains information in the service code field and information indicating a corresponding URL may be encrypted and stored.

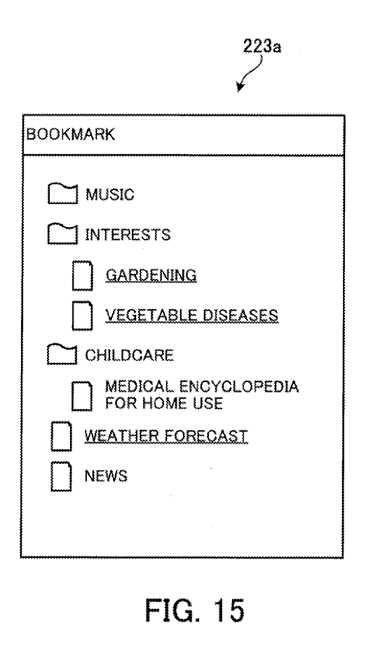

FIG. 15 illustrates an example display of bookmark information on a PC. This example display of FIG. 15 is based on the example of registered data of FIG. 14.

The bookmark processing unit 222 displays, for example, a bookmark screen 223a for displaying a list of information registered in the bookmark information 223, on the monitor 204a in accordance with selection operation made on a bookmark display button on the screen of a Web browser. Referring to FIG. 15, the bookmark screen 223a displays folders, “music”, “interests”, and “childcare”, for example. In this connection, folders displayed on the bookmark screen 223a may be managed by using folder management information (not illustrated).

In addition, the bookmark processing unit 222 displays the bookmark screen 223a based on the bookmark information 223 of FIG. 14 as follows. The bookmark processing unit 222 displays the names of webpages, “weather forecast” and “news”, in the root hierarchy. The bookmark processing unit 222 also displays the names of webpages, “gardening” and “vegetable diseases”, under the “interests” folder, and also displays the name of a webpage, “medical encyclopedia for home use”, under the “childcare” folder.

When a user selects one of the webpage names displayed on the bookmark screen 223a, the bookmark processing unit 222 extracts the URL corresponding to the selected name from the bookmark information 223, and notifies the Web browsing unit 221 of the URL. The Web browsing unit 221 accesses the received URL to display the webpage indicated by the URL on the monitor 204a.

In this connection, when the bookmark processing unit 222 displays the bookmark screen 223a, the information addition unit 232 may display webpage names having service codes attached thereto in such a way as to indicate that these webpages are available with discount services. Referring to FIG. 15, each name of “gardening”, “vegetable diseases”, and “weather forecast” having a service code attached thereto in the bookmark information 223 is underlined to indicate that they are available with a discount service. As another means to indicate that they are available with a discount service, these webpage names may be displayed in different color, or some mark may be attached to the names.

By specifically indicating webpages available with the discount services, the user of the PC 200 can recognize that the user is able to view these webpages with the mobile telephone 300 at discounted communication charges. In addition, on the bookmark screen 223a, not only a service code is attached, but also a service code type (that is, discount rate) may be displayed so that the user recognizes the service code type.

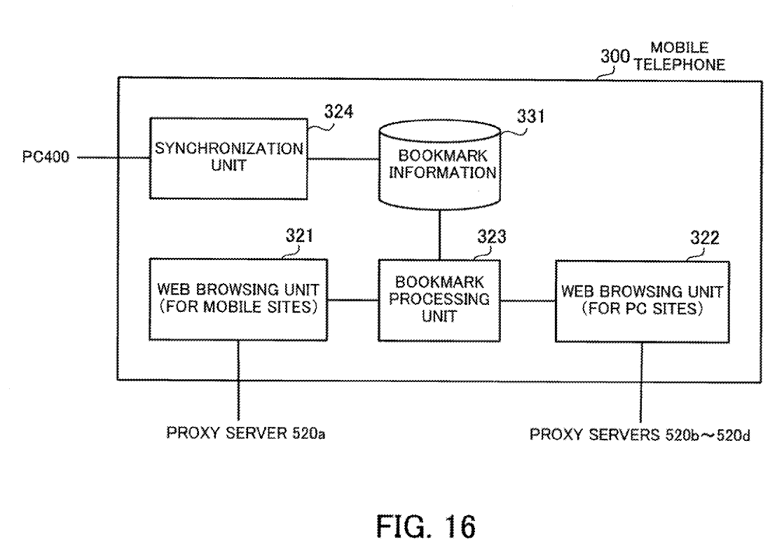

The following describes processes of the mobile telephone 300. FIG. 16 is a block diagram illustrating an example configuration of processing functions of a mobile telephone.

The mobile telephone 300 includes Web browsing units 321 and 322, a bookmark processing unit 323, and a synchronization unit 324. The processes of each block are realized by the CPU 301 of the mobile telephone 300 executing predetermined programs, for example. In this connection, the processes of the Web browsing units 321 and 322 are realized by executing a Web browser program for displaying mobile sites and a Web browser program for displaying PC sites, respectively. In addition, the non-volatile memory 304 of the mobile telephone 300 stores bookmark information 331.

The Web browsing units 321 and 322 communicate with a Web server, and display webpages provided by the Web server on the monitor 306a. The Web browsing unit 321 performs a process especially for displaying mobile version websites (mobile sites). On the other hand, the Web browsing unit 322 displays a browser screen for properly displaying PC-based websites (PC sites), and is generally called “full browser”.

The Web browsing unit 321 accesses a Web server via a proxy server 520a of a carrier system 550, which will be described later. On the other hand, the Web browsing unit 322 accesses a Web server via one of proxy servers 520b to 520d of the carrier system 500.

When the bookmark processing unit 323 receives a bookmark request while a webpage is displayed by one of the Web browsing units 321 and 322, the bookmark processing unit 323 acquires the name and URL of the webpage currently displayed from the one of the Web browsing units 321 and 322, and registers them in the bookmark information 331.

In addition, when the bookmark processing unit 323 receives selection of a webpage name registered in the bookmark information 331, the bookmark processing unit 323 notifies one of the Web browsing units 321 and 322 of the URL corresponding to the selected webpage in order to request display of the webpage. In the case where a service code has been attached to the selected webpage in the bookmark information 331, the bookmark processing unit 323 notifies the Web browsing unit 322 of the URL corresponding to the selected webpage in order to request display of the webpage. At the same time, the bookmark processing unit 323 requests the Web browsing unit 322 to access a proxy server corresponding to the service code.

When detecting connection of the mobile telephone 300 to the PC 200, the synchronization unit 324 automatically starts up. The synchronization unit 324 receives bookmark information from the PC 400, and registers the received bookmark information in a predetermined region of the bookmark information 331.

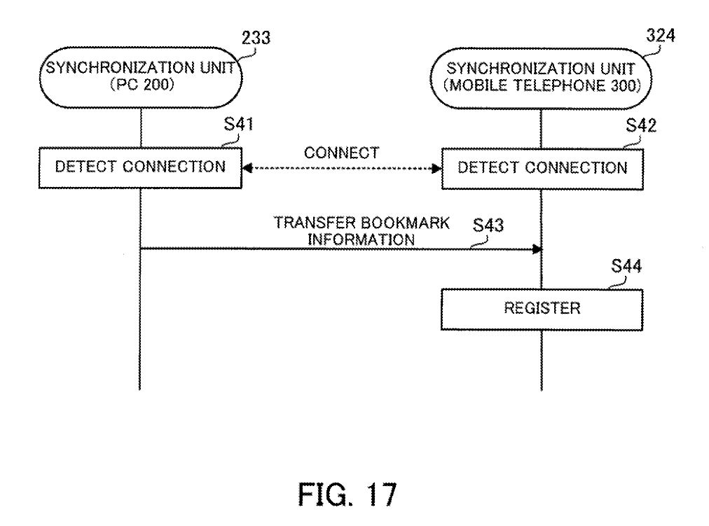

The following describes how to transfer bookmark information from the PC 200 to the mobile telephone 300. FIG. 17 is a sequence diagram illustrating how to transfer bookmark information.

When the communication interface 208 of the PC 200 is connected to the communication interface 308 of the mobile telephone 300, the synchronization unit 233 of the PC 200 detects this connection to the mobile telephone 300 (step S41). The synchronization unit 324 of the mobile telephone 300 also detects this connection to the PC 200 (step S42). At this time, the synchronization unit 324 gets in a waiting mode for receiving information from the PC 200. Alternatively, the synchronization unit 324 may request the PC 200 to transfer bookmark information.

The synchronization unit 233 of the PC 200 retrieves the bookmark information 223 from the HDD 203, and transfers the bookmark information 223 to the mobile telephone 300 via the communication interface 208 (step S43). The synchronization unit 324 of the mobile telephone 300 receives the bookmark information 223 from the PC 200, and registers the bookmark information 223 in the non-volatile memory 304 as part of the bookmark information 331 stored in the mobile telephone 300 (step S44).

In this connection, in this transfer of the bookmark information, the synchronization unit 233 of the PC 200 may extract only information that has not been registered in the bookmark information 331 of the mobile telephone 300 out of the bookmark information 223 registered in the PC 200, and transfer the extracted information to the mobile telephone 300.

In addition, in this embodiment, the bookmark information is directly transferred from the PC 200 to the mobile telephone 300. Alternatively, the PC 200 may transmit the bookmark information to the mobile telephone 300 via a server device. More specifically, the synchronization unit 233 of the PC 200 registers the bookmark information 223 in the server device connected to the Internet 100 every time the bookmark information 223 of the PC 200 is updated or at predetermined intervals. The synchronization unit 324 of the mobile telephone 300 accesses the server device, at predetermined intervals or at predetermined timing such as when a Web browser starts or another event, and acquires the registered bookmark from the server device.

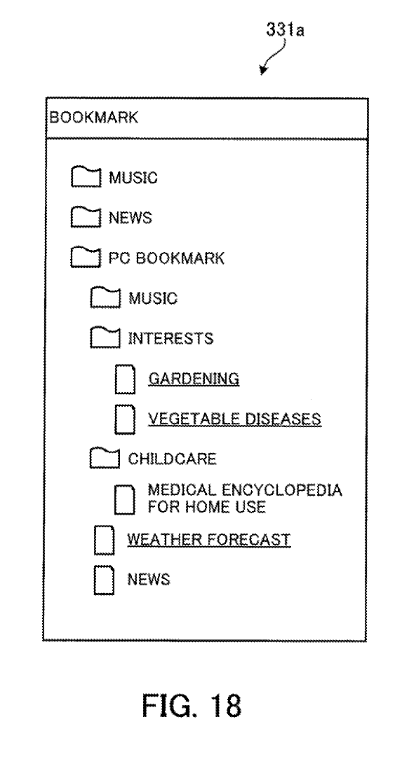

FIG. 18 illustrates an example display of bookmark information on a mobile telephone.

The bookmark information 331 registered in the mobile telephone 300 has the same data structure as the bookmark information 223 of the PC 200 illustrated in FIG. 15. In the bookmark information 331 of the mobile telephone 300, for example, a folder, “PC bookmark”, dedicated for registering bookmark information transferred from the PC 200 is created. For example, the synchronization unit 324 creates the “PC bookmark” folder for the bookmark information 331 when bookmark information transferred from the PC 200 is first registered, and registers the bookmark information received from the PC 200 under the created folder.

A bookmark screen 331a of FIG. 18 is an example of displaying the contents of the bookmark information 331 registered in the above-described manner. In this bookmark screen 331a, the folder names and webpage names displayed on the bookmark screen 223a illustrated in FIG. 15 are displayed in the same manner under the “PC bookmark” folder.

In this connection, the “PC bookmark” folder may be previously set in the bookmark information 331. Alternatively, bookmark information transferred from the PC 200 may be registered under a folder specified by a user.

In addition, the bookmark screen 331a displays webpage names having service codes attached thereto in such a manner as to indicate that the webpages with these webpage names are available with discount services. This enables the user of the mobile telephone 300 to recognize webpages available with a discount service for communication charges. Referring to the example of FIG. 18, each webpage name of “gardening”, “vegetable diseases”, and “weather forecast” each having a service code attached thereto is underlined. As another means to indicate that they are available with a discount service, these webpage names may be displayed in different color, or some mark may be attached to the webpage names. In addition, webpage names may be displayed in different manners according to discount rates.

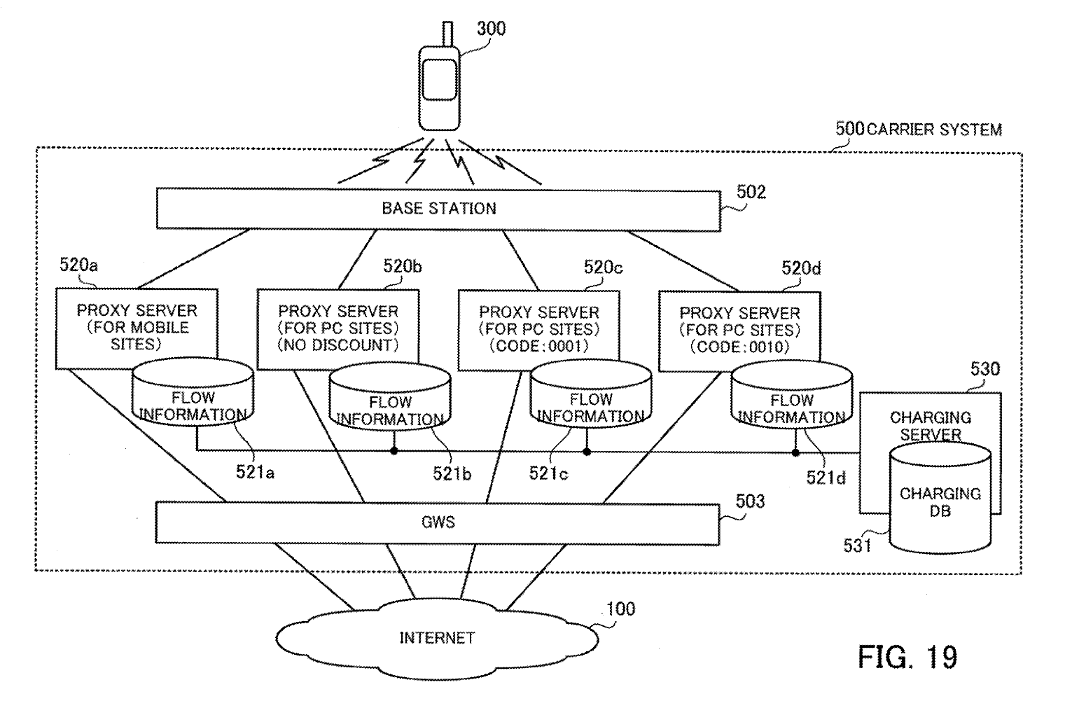

The following describes how the mobile telephone 300 displays a webpage. First, FIG. 19 illustrates an example of internal configuration of a carrier system.

To a network 501 (not illustrated) in the carrier system 500, proxy servers 520a to 502d and a charging server 530, as well as the base station 502 and gateway server 503, are connected.

The proxy servers 520a to 520d relay accesses from the mobile telephone 300 to Web servers. The mobile telephone 300 accesses a Web server via one of the proxy servers 520a to 520d. Different communication charges are set for the respective proxy servers that are accessed by the mobile telephone 300 for displaying webpages.

The mobile telephone 300 accesses the proxy server 520a when displaying a mobile site's webpage. At this time, a communication charge for mobile sites is applied to the mobile telephone 300. In addition, the mobile telephone 300 accesses the proxy server 520b when displaying a PC site's webpage which is not available with a discount. At this time, a communication charge for PC sites is applied to the mobile telephone 300.

In addition, the mobile telephone 300 accesses one of the proxy servers 520c and 520d to display a PC site's webpage having a service code attached thereto, in accordance with selection operation with respect to the bookmark information 331. For example, the mobile telephone 300 accesses the proxy server 520c in the case where the service code is “0001”. In this case, the mobile telephone 300 receives a discount on a communication charge for PC sites at a discount rate corresponding to the service code of “0001”. On the other hand, the mobile telephone 300 accesses the proxy server 520d in the case where the service code is “0010”. In this case, the mobile telephone 300 receives a discount on a communication charge for PC sites at a discount rate corresponding to the service code of “0010”.

The proxy servers 520a to 520d store flow information 521a to 521d, respectively. The flow information 521a to 520d includes a communication data volume and date and time of a webpage display process, in association with a user ID identifying a user.

The charging server 530 calculates a communication charge for charging a user. The charging server 530 periodically collects the flow information 521a to 521d from the proxy servers 520a to 520d, and registers the information in a charging database 531. The charging server 530 adds information indicating which proxy server flow information came from, in association with the flow information in the charging database 531. The charging server 530 refers to the charging database 531 to calculate a communication charge for a predetermined period for each user on the basis of the communication data volume and the communication charges corresponding to the proxy serves which supplied the flow information.

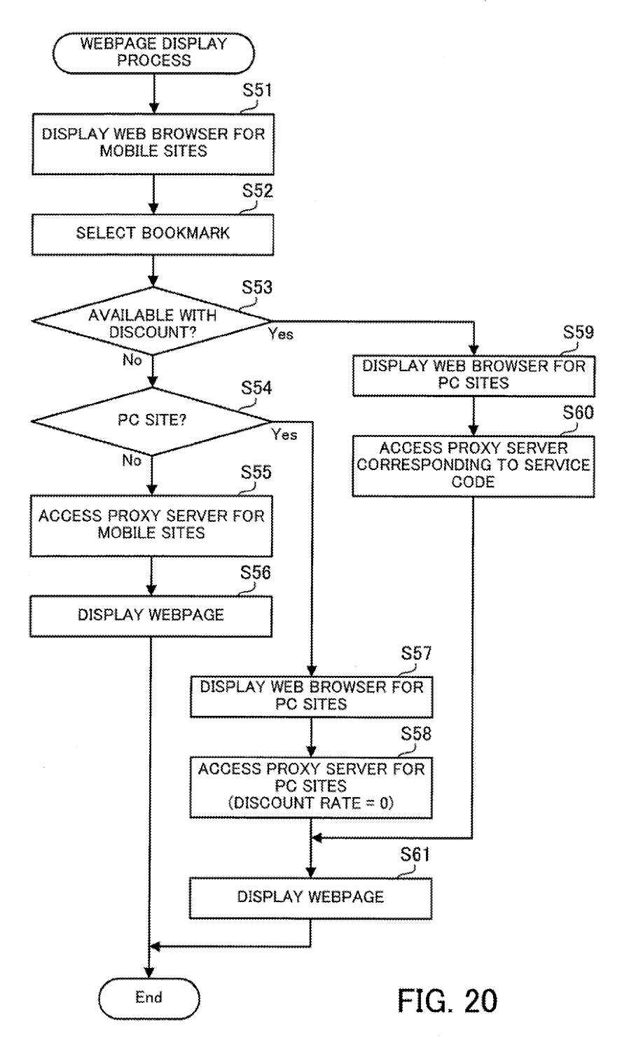

FIG. 20 is a flowchart illustrating an example of a procedure for displaying a webpage using bookmark information.

At step S51, an initial state for the procedure of FIG. 20 is that, for example, any Web browser for mobile sites or PC sites is not displayed. Under this state, when a command to start a Web browser is issued in accordance with user's operation, the Web browsing unit 321 starts up, and a Web browser for mobile sites is displayed on the monitor 306a.

At step S52, the bookmark processing unit 323 displays a bookmark screen 331a on the monitor 306a in accordance with user's operation. Then, when one webpage name is selected on the bookmark screen 331a, the bookmark processing unit 323 executes step S53.

At step S53, the bookmark processing unit 323 determines whether the webpage indicated by the selected webpage name is available with a discount service. The bookmark processing unit 323 checks the bookmark information 331, and determines that the webpage is available with a discount service in the case where a service code has been attached to the selected webpage name.

The bookmark processing unit 323 executes step S59 in the case where the webpage is available with a discount service. Otherwise, the bookmark processing unit 323 executes step S54.

At step S54, the bookmark processing unit 323 determines whether the webpage indicated by the selected webpage name is a mobile site's webpage or PC site's webpage. In this process, for example, the bookmark processing unit 323 displays a screen on the monitor 306a for causing the user to confirm whether the selected webpage name is the name of a PC site's webpage or not, and determines whether the webpage is a mobile site's webpage or a PC site's webpage in accordance with input operation by the user viewing the screen. In the case where the webpage is a mobile site's webpage, the bookmark processing unit 323 executes step S55. In the case where the webpage is a PC site's webpage, the bookmark processing unit 323 executes step S57.

At step S55, the bookmark processing unit 323 extracts the URL corresponding to the webpage name selected at step S52, from the bookmark information 331, and notifies the Web browsing unit 321 of the extracted URL to request display of the webpage. The Web browsing unit 321 accesses the proxy server 520a to request an access to the URL received from the bookmark processing unit 323. The proxy server 520a accesses the Web server corresponding to the requested URL, and sends response information to the mobile telephone 300.

At step S56, the Web browsing unit 321 displays the webpage on the Web browser for mobile sites on the basis of the response information received from the proxy server 520a.

At step S57, the bookmark processing unit 323 finishes the process of the Web browsing unit 321, closes the Web browser for mobile sites, and activates the Web browsing unit 322. The Web browsing unit 322 displays a Web browser for PC sites on the monitor 306a.

At step S58, the bookmark processing unit 323 extracts the URL corresponding to the webpage name selected at step S52, from the bookmark information 331, and notifies the Web browsing unit 322 of the extracted URL to request display of the webpage. The Web browsing unit 322 accesses the proxy server 520b to request an access to the URL received from the bookmark processing unit 323. The proxy server 520b accesses the Web server corresponding to the requested URL, and sends response information to the mobile telephone 300.

At step S59, the bookmark processing unit 323 finishes the process of the Web browsing unit 321, closes the Web browser for mobile sites, and activates the Web browsing unit 322. The Web browsing unit 322 displays a Web browser for PC sites on the monitor 306a.

At step S60, the bookmark processing unit 323 extracts the URL and service code corresponding to the webpage name selected at step S52, from the bookmark information 331, and notifies the Web browsing unit 322 of the extracted URL to request display of the webpage.

The Web browsing unit 322 accesses a proxy server (one of proxy servers 520c and 520d) corresponding to the service code received from the bookmark processing unit 323 to request an access to the URL received from the bookmark processing unit 323. The accessed proxy server accesses the Web server corresponding to the requested URL, and sends response information to the mobile telephone 300.

At step S61, the Web browsing unit 321 displays the webpage on the Web browser for PC sites on the basis of the response information from the proxy server accessed at step S58 or S60.

According to the above procedure of FIG. 20, when the user is to select a website name on the bookmark screen 331a to view a website, the mobile telephone 300 automatically accesses an appropriate proxy server according to a discount rate in the case where the selected webpage name is the name of a webpage available with a discount service. As a result, a communication charge for displaying a webpage is discounted according to a service code.

In this connection, although FIG. 20 illustrates the case where a webpage name on the bookmark screen 331a is received under the state where any of Web browsers for mobile sites and PC sites is not displayed, the process of step S52 may be executed under the state where a webpage is displayed on the Web browser for mobile sites.

In addition, when a webpage name is selected on the bookmark screen 331a while a webpage is displayed on the Web browser for PC sites, for example, step S53 is executed. Then, in the case where the selected webpage name is the name of a webpage available with a discount service, step S59 is executed, and in the case where the selected webpage name is not the name of a webpage available with a discount service, step S57 is executed.

According to the above-described second embodiment, the user is able to use bookmark information with both the PC 200 and mobile telephone 300. Therefore, even in the case where the user uses the mobile telephone 300 to view a webpage that the user usually views with the PC 200, the user is able to easily view the webpage by selecting the webpage on the bookmark screen 331a.

In addition, the user is able to view webpages predetermined by a mobile phone carrier with the mobile telephone 300 via an Internet provider specified by the mobile phone carrier at low cost, out of webpages that the user often views with the PC 200. The user is able to receive a discount service for a communication charge only by bookmarking a URL on the PC 200 and connecting the PC 200 to the mobile telephone 300.

By the way, as described earlier, service codes stored in the bookmark information 223 in the PC 200 and service codes stored in the bookmark information 331 in the mobile telephone 300 are information that proves that the user can receive discount services. Therefore, these service codes are preferably stored so as not to allow fraudulent use. For example, in the case where a combination of a bookmarked URL and a service code is distributed, and the combination is easily added to the bookmark information 331 of the mobile telephone 300, the communication charge of the mobile telephone 300 is illegally discounted.

To prevent the fraudulent use of service codes, there is a method of encrypting at least a combination of a service code and information indicating the URL corresponding to this service code using a predetermined encryption key.

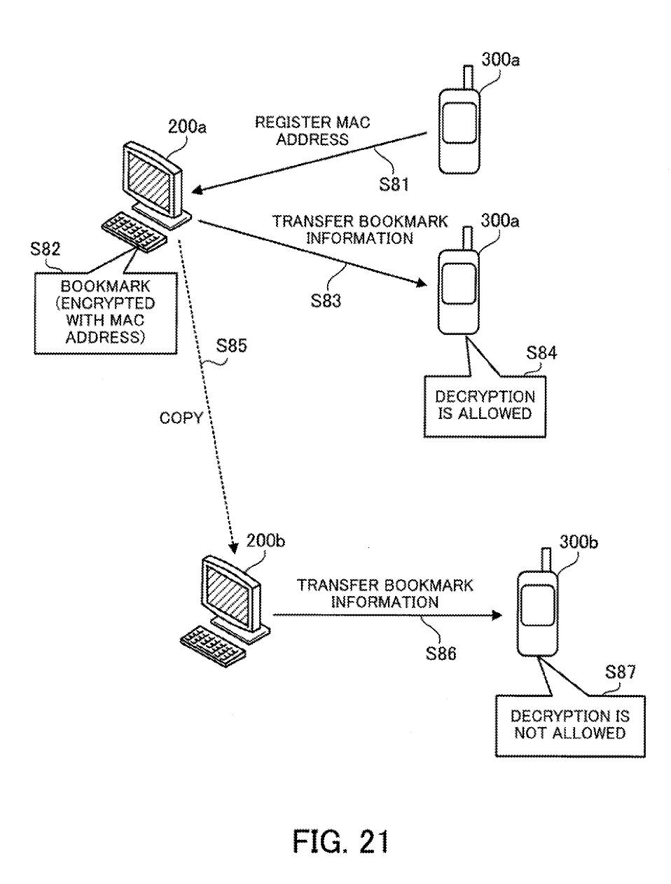

FIG. 21 illustrates a process for encrypting bookmark information using the identification information of a mobile telephone. As the identification information of the mobile telephone 300, a Media Access Control (MAC) address of the mobile telephone 300 is used.

In FIG. 21, assume that a rightful user uses the PC 200a and mobile telephone 300a. The user connects the PC 200a to the mobile telephone 300a to register the MAC address of the mobile telephone 300a in the PC 200a in advance (step S81). For example, a synchronization unit 324 of the mobile telephone 300a sends the MAC address of the mobile telephone 300a to the PC 200a, and a synchronization unit 233 of the PC 200a stores the MAC address received from the mobile telephone 300a in a non-volatile memory such as a HDD 203.

Then, when operation for bookmarking is performed in the PC 200a, a bookmark processing unit 222 of the PC 200a encrypts the webpage name and URL requested to be bookmarked, with the MAC address of the mobile telephone 300a as an encryption key, and registers the encrypted webpage name and URL in bookmark information 223. At this time, in the case where a service code is attached to the URL, an information addition unit 232 of the PC 200a encrypts the service code with the MAC address of the mobile telephone 300a as an encryption key, and registers the encrypted service code in the bookmark information 223 (step S82). In this connection, out of the information registered in the bookmark information 223, only the service code, and the webpage name and URL having the service code attached thereto may be encrypted.

Then, when the mobile telephone 300a is connected to the PC 200a, the synchronization unit 233 of the PC 200a transfers the bookmark information 223 to the mobile telephone 300a (step S83). The synchronization unit 324 of the mobile telephone 300a adds and registers the received bookmark information in the bookmark information 331 in the mobile telephone 300a. The encrypted information added and registered in the bookmark information 331 can be decrypted with the MAC address of the mobile telephone 300a as a decryption key (step S84).

Assume now, for example, that the bookmark information 223 registered in the PC 200a is illegally copied to another PC 200b (step S85). When a mobile telephone 300b other than the above mobile telephone 300a is connected to the PC 200b, the PC 200b transfers the bookmark information 223 copied from the PC 200a to the mobile telephone 300b (step S86). However, the mobile telephone 300b is not able to decrypt the bookmark information received from the PC 200b with the MAC address of the mobile telephone 300b as a decryption key (step S87). As a result, the fraudulent use of the service code and an illegal discount on the communication charge of the mobile telephone 300b are prevented.

In this connection, as another method for preventing the fraudulent use of a service code, there is a method of encrypting bookmark information registered in a PC with the identification information (MAC address or the like) of the PC. In this case, a path for transferring the encrypted bookmark information to a mobile telephone and a path to notify the mobile telephone of the decryption key (the identification information of the PC) are preferably different from each other. For example, the PC stores the encrypted bookmark information in a server device, and the mobile telephone acquires the bookmark information from the server device. In addition to this, the mobile telephone acquires the identification information of the PC by directly connecting to the PC. This enables the mobile telephone to decrypt the bookmark information acquired from the server device only when the mobile telephone connects to the PC which encrypted the bookmark information.

The above processing functions of apparatuses (for example, information processing apparatus 10, 20, PC 200, and mobile telephone 300) illustrated in the above embodiments can be realized by a computer. In this case, a program is prepared, which describes the processing contents of the functions of the above apparatus. The above processing functions are realized on the computer by executing the program. The program describing the needed processes may be recorded on a computer-readable recording medium. Computer-readable recording media include magnetic storage devices, optical discs, magneto-optical recording media, semiconductor memories, etc. The magnetic storage devices include Hard Disk Drives (HDD), Flexible Disks (FD), magnetic tapes, etc. The optical discs include DVDs, DVD-RAMS, CD-ROMs, CD-R/RWs, etc. The magneto-optical recording media include Magneto-Optical disks (MO), etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the above program stores, in a local storage device, the program recorded on a portable recording medium or transferred from the server computer, for example. Then, the computer reads the program from the local storage device, and runs the program. The computer may run the program directly from the portable recording medium. Also, while receiving the program being transferred from the server computer connected via a network, the computer may sequentially run this program.

The above information processing program, information processing apparatus, information processing system, and information processing method enable one apparatus to acquire information via one connection system at low cost, which another apparatus acquired via another connection system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A computer-readable, non-transitory medium encoded with an information processing program executed by a computer connected to a network via a first connection system and having a function of registering an identifier of information acquired via the network and the first connection system in a memory provided in the computer, the information processing program causing the computer to perform a procedure comprising:
in registering the identifier in the memory, determining whether or not a discount applies to a communication charge for acquiring the information identified by the identifier via a second connection system, and upon determining that the discount applies, registering the identifier with discount information attached thereto in the memory; and
transmitting the identifier and the discount information registered in the memory to another information processing apparatus connected to the network via the second connection system.

2. The computer-readable, non-transitory medium according to claim 1, wherein the identifier and the discount information registered in the memory are transmitted to said another information processing apparatus as bookmark information that is used for acquiring the information identified by the identifier via the network and the second connection system and for performing a process for receiving the discount on the communication charge for acquiring the information identified by the identifier having the discount information attached thereto.

3. The computer-readable, non-transitory medium according to claim 1, wherein the procedure further comprises, in registering the identifier in the memory, determining whether or not the first connection system is a connection system previously specified in association with the second connection system, and upon determining that the first connection system is the connection system previously specified and that the discount applies to the communication charge for acquiring the information identified by the identifier via the second connection system, registering the identifier with the discount information attached thereto in the memory.

4. The computer-readable, non-transitory medium according to claim 1, wherein the procedure further comprises, in registering the identifier with the discount information attached thereto in the memory, including information according to a discount rate for the communication charge in the discount information.

5. An information processing apparatus connected to a network via a first connection system, the information processing apparatus comprising:
a memory; and
one or more processors configured to perform a procedure comprising:
receiving, from another information processing apparatus connected to the network via a second connection system, an identifier of information acquired by said another information processing apparatus via the network and the second connection system, registering the identifier in the memory, and in a case where said another information processing apparatus has determined that a discount applies to a communication charge for acquiring the acquired information via the first connection system, receiving discount information attached to the identifier from said another information processing apparatus, and registering the discount information together with the identifier in the memory; and
acquiring information identified by an identifier selected from the memory via the network and the first connection system, and upon determining that discount information has been attached to the selected identifier, performing a discount process for receiving a discount on a communication charge for acquiring the information identified by the selected identifier.

6. The information processing apparatus according to claim 5, wherein the discount process includes accessing a server different from servers that do not provide the discount on the communication charge, out of a plurality of servers that is included in the first connection system and performs a process of connecting to the network.

7. The information processing apparatus according to claim 5, wherein:
the discount information received from said another information processing apparatus includes information according to a discount rate; and
the discount process is performed for receiving the discount rate for the communication charge based on the discount information attached to the selected identifier.

8. The information processing apparatus according to claim 7, wherein the discount process includes accessing a server that provides the discount rate based on the discount information attached to the selected identifier, out of a plurality of servers that is included in the first connection system and provides different discount rates for communication charges for performing a process of connecting to the network.

9. An information processing system comprising:
a first information processing apparatus connected to a network via a first connection system; and
a second information processing apparatus connected to the network via a second connection system, wherein:
the first information processing apparatus is configured to perform a first procedure comprising:
registering an identifier of information acquired via the network and the first connection system in a first memory of the first information processing apparatus, and determining whether or not a discount applies to a communication charge for acquiring the information identified by the identifier via the second connection system, and upon determining that the discount applies, registering the identifier with discount information attached thereto in the first memory; and
transmitting the identifier and the discount information registered in the first memory to the second information processing apparatus; and
the second information processing apparatus is configured to perform a second procedure comprising:
registering the identifier and the discount information received from the first information processing apparatus in a second memory of the second information processing apparatus; and
acquiring information identified by an identifier selected from the second memory via the network and the second connection system, and upon determining that discount information has been attached to the selected identifier, performing a discount process for receiving a discount on a communication charge for acquiring the information identified by the selected identifier.

10. The information processing system according to claim 9, wherein the first procedure further comprises determining whether or not the first connection system is a connection system previously specified in association with the second connection system, and upon determining that the first connection system is the connection system previously specified and that the discount applies to the communication charge for acquiring the information identified by the identifier via the second connection system, registering the identifier with the discount information attached thereto in the first memory.

11. The information processing system according to claim 9, wherein the discount process includes accessing a server different from servers that do not provide the discount on the communication charge, out of a plurality of servers that is included in the second connection system and performs a process of connecting to the network.

12. The information processing system according to claim 9, wherein:
the first procedure further comprises, in registering the identifier with the discount information attached thereto in the first memory, including information according to a discount rate for the communication charge in the discount information; and
the second procedure performs the discount process for receiving the discount rate for the communication charge based on the discount information attached to the selected identifier.

13. The information processing system according to claim 12, wherein the discount process includes accessing a server that provides the discount rate based on the discount information attached to the selected identifier, out of a plurality of servers that is included in the second connection system and provides different discount rates for communication charges for performing a process of connecting to the network.
